(19) United States
(12) Patent Application Publication
(10) Pub. No.: US 2003/0004044 A1
(43) Pub. Date: Jan. 2, 2003

(54) Octagonal bulk box

(76) Inventor: Randy Kelley, Covington, LA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/093,984

(22) Filed: Mar. 7, 2002

Related U.S. Application Data
(60) Provisional application No. 60/273,857, filed on Mar. 7, 2001.

(51) Int. Cl. B31B 49/00

(52) U.S. Cl. 493/51

(57) ABSTRACT

A system and method of flaps and notches for use in the assembly and use of boxes. The system includes a box formed from a unitary blank of material. The unitary blank has a plurality of sidewalls, each of the plurality of sidewalls is foldably connected to an adjacent sidewall. The unitary blank also includes a plurality of flaps that has a main flap, a pair of side flaps, and a closure flap, each of the flaps having an attached edge, a pair of side edges, and a free edge. Each of the flaps is foldably connected to a separate one of the sidewalls. The unitary blank further has a plurality of alignment notches, each of the alignment notches is arranged and configured to engage an adjacent side edge of an adjacent one of the flaps. Each of the side edges of the main flap also includes an alignment notch, and the main flap, the pair of side flaps, and the closure flap form a bottom of the box when folded perpendicular to the plurality of sidewalls.

### CROSS-REFERENCE TO RELATED APPLICATION

This application claims priority to copending U.S. provisional application entitled, “Octagonal Bulk Box,” having Serial No. 60/273,857, filed Mar. 7, 2001, which is incorporated herein by reference.

### TECHNICAL FIELD OF THE INVENTION

The invention generally relates to bulk boxes for receiving and storing goods and, more particularly, to an improved system and method of erecting bulk boxes.

### BACKGROUND OF THE INVENTION

In many applications, it is often desirable to achieve economies by receiving and storing large amounts of products in stackable boxes. As well, maximizing the size of the boxes helps to keep costs down in that fewer boxes are required. Less effort is also required to move loads stored in the larger boxes in that more product is moved per trip, as with a forklift truck, than with more numerous, smaller boxes. However, as the size of the boxes, and substantially the size of the sidewalls increase, the stackability suffers in that the larger sidewalls are more prone to collapse under vertical loading. This is especially the case in those boxes having dimensions of several feet that are used to store and transport loads often weighing thousands of pounds, i.e., resin beads, powders, bulk produce, etc.

To help maintain stackability while using larger boxes, it is desirable to use boxes having an octagonal shape. Rather than having four side walls that intersect in four ninety degree corners, octagonal boxes, as the name suggests, are eight sided. Rather than having the four ninety degree corners as in a standard box, each corner has been replaced with yet another sidewall that in essence, “cuts the corner.” This structure provides much greater vertical stability to allow greater loads to be supported by each box.

However, octagonal boxes are not without their own problems. Quite often, octagonal boxes are used in concert with pallets to facilitate stacking, movement, and increase the load each box may hold. However, in that these boxes are rather large and tend to be constructed of heavy materials, the boxes experience “memory.” This means that the materials tend to resist maintaining the proper form. The resulting biased attitude of the box may result in the box being structurally impaired because it is “off the platform,” meaning portions of the box may no longer be supported by the pallet. Also, the heft of the materials and size of the boxes require excessive manipulation on the part of the person erecting the box to get it in the proper form and maintain that form.

Prior art attempts to solve these problems have included the use of such items as “squaring jigs.” Although the jigs do help reduce the potential for biased attitude and potential failure of the octagonal boxes, their use adds to both the cost of assembling the boxes as well as the overall number of steps required to complete assembly.

### SUMMARY OF THE INVENTION

The problem of maintaining a box in the proper attitude described above is overcome without squaring jigs and the additional steps required for their use. In accordance with the present invention, a sequence of flap folds along with a “notching” of the flaps is utilized to aid in setting up the box and maintaining the box in the proper attitude.

An embodiment of the present invention includes a box formed from a unitary blank of material. The unitary blank has a plurality of sidewalls, each of the plurality of sidewalls is foldably connected to an adjacent sidewall. The unitary blank also includes a plurality of flaps that has a main flap, a pair of side flaps, and a closure flap, each of the flaps having an attached edge, a pair of side edges, and a free edge. Each of the flaps is foldably connected to a separate one of the sidewalls. The unitary blank further has a plurality of alignment notches, each of the alignment notches is arranged and configured to engage an adjacent side edge of an adjacent one of the flaps. Each of the side edges of the main flap also includes an alignment notch, and the main flap, the pair of side flaps, and the closure flap form a bottom of the box when folded perpendicular to the plurality of sidewalls.

Another embodiment of the present invention includes a method of forming a box. The method includes the steps of folding a unitary blank such that a plurality of sidewalls is formed, one of the sidewalls including a first and second portion that are joined by a securing means. Next, a pair of side flaps is engaged with a pair of alignment notches disposed on a main flap by folding the main flap inwardly until the main flap is perpendicular to the plurality of sidewalls. The pair of side flaps is then folded inwardly until each of the side flaps is perpendicular to the plurality of sidewalls. A closure flap is folded inwardly until the closure flap is perpendicular to said plurality of sidewalls, and then secured in position perpendicular to the plurality of sidewalls, thereby forming a bottom of the box.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a top view of an octagonal box blank of the present invention showing a preferred embodiment of notch location, shape, and size.

FIG. 2 is a bottom perspective view of the octagonal box shown in FIG. 1, showing the first flap as folded into position.

FIG. 3 is a bottom perspective view of the octagonal box shown in FIG. 2, showing the second and third flaps as folded into position.

FIG. 4 is a bottom perspective view of the octagonal box shown in FIG. 3, showing the fourth flap as folded into position and completing the assembly of the box.

### DETAILED DESCRIPTION

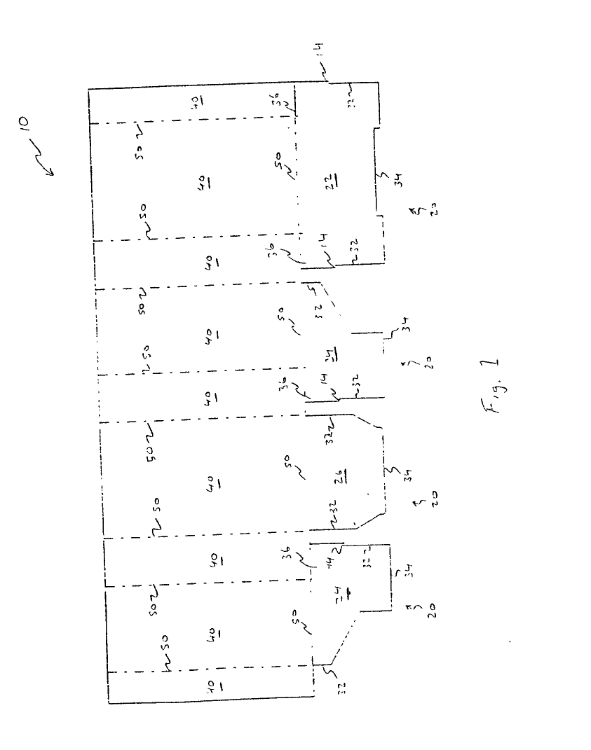

Referring now to FIG. 1, prior to assembly of the octagonal box, a unitary blank 10 is produced having the desired dimensions. In the preferred embodiment shown, alignment notches 14, are formed on portions of the flaps 20 to aid in both alignment of the side walls 40 during assembly, and to maintain proper attitude of the octagonal box upon completion as well. Each flap 20 is foldably connected to the unitary blank 10 along an attached edge 30, and further includes a pair of side edges 32 and a free edge 34. Also, the main flap 22 and pair of side flaps 24 also include corner tabs 36 which assist in stabilizing the box after construction by both increasing the surface area of the bottom and allowing the box to be secured to a pallet. Fold lines 50 separate the sidewalls 40 from each other as well as the flaps 20 from the unitary blank 10. The fold lines 50 assist in assembly of the box. A closure flap 26 is also provided. Assembly of the octagonal box of the preferred embodiment will now be discussed.

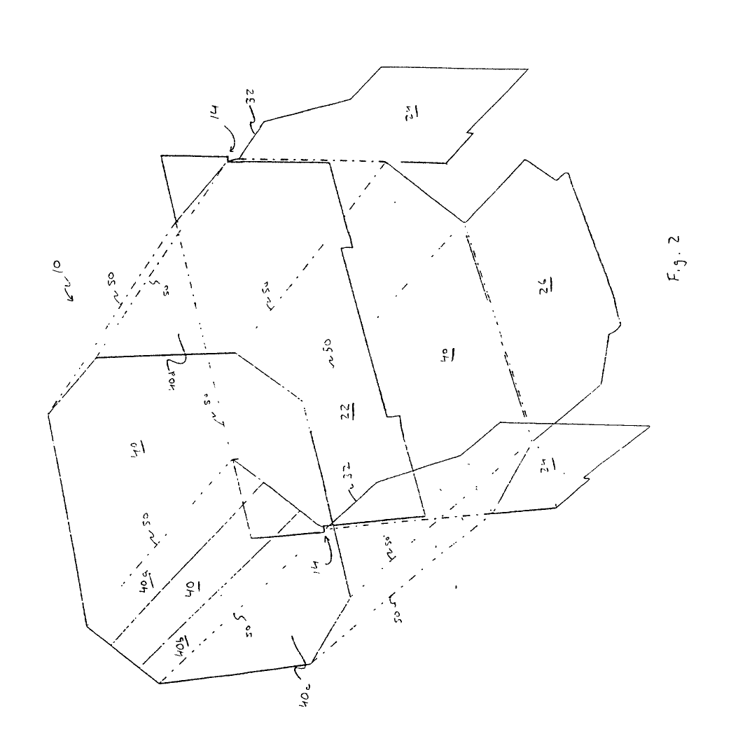

Referring now to FIG. 2, the sidewall 40 portion of the octagonal box has been formed by keeping one sidewall 40 stationary and folding the unitary blank 10 along fold lines 50 separating the individual sidewalls 40. The two outermost sidewalls 40a and 40b overlap and are joined by any adequate securing means, such as glue, tape, staples, etc., to form a single sidewall 40. All that remains is the formation of the bottom of the octagonal box to complete assembly.

The main flap 22 is folded along its associated fold line 50 until it is perpendicular to the sidewall 40 portion (FIG. 2). The alignment notches 14 located on the side edges 32 of the main flap 22 extend slightly beyond sidewalls 40c and 40d, and above the adjacent side edges 32 of the pair of side flaps 24. This arrangement ensures the alignment notches 14 will engage the side edges 32, meaning the main flap 22 will remain in proper position as the rest of the bottom is assembled.

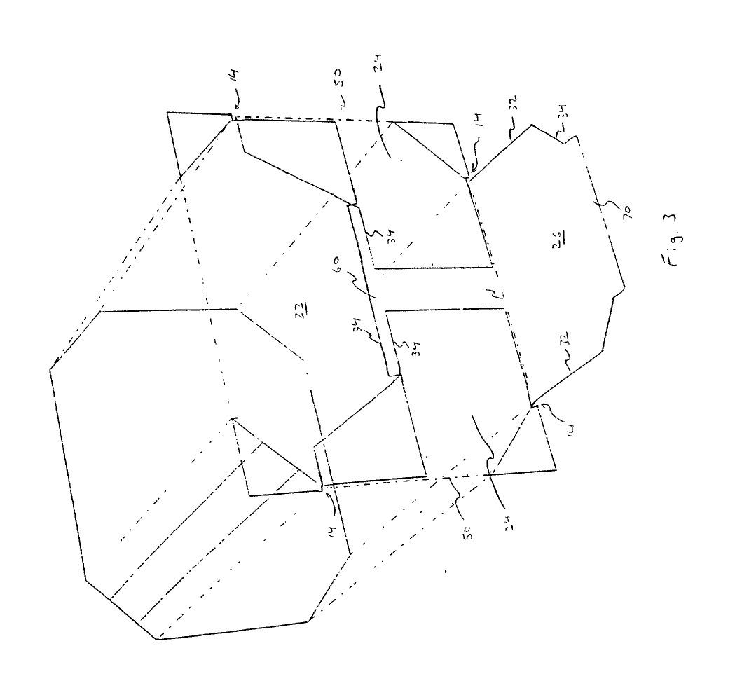

As shown in FIG. 3, the side flaps 24 are folded along their respective fold lines 50 until perpendicular to the sidewall 40 portion. The side edges 32 of the side flaps 24 that are adjacent to the closure flap 26 include alignment notches 14. By folding the side flaps 24 inward, the alignment notches 14 are brought into abutment with the side edges 32 of the closure flap 26. In the preferred embodiment shown, folding the main flap 22 and side flaps 24 in this manner causes a recess 60 to be formed by the free edges 34 of the flaps. Recess 60 is configured to receive securing tab 70 disposed on the free edge 34 of the closure flap 26.

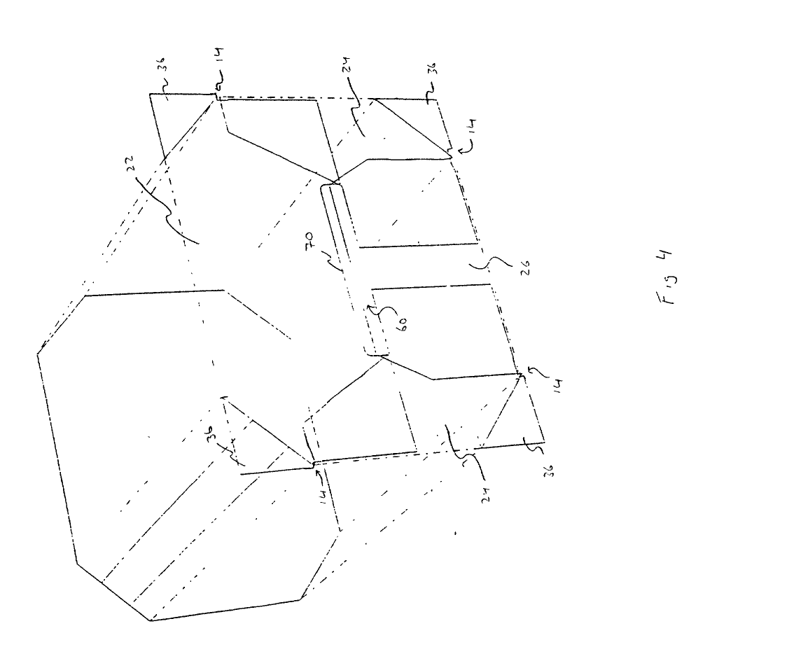

To complete assembly of the octagonal box, the closure flap 26 is folded along its respective fold line 50 and securing tab 70 is pushed through recess 60 , as shown in FIG. 4. As described, the bottom is self-locking and complete. The bottom can also be modified so that it is not self-locking, and the same configuration of alignment notches 14 and flaps 22, 24 and 26, could be used to facilitate assembly and maintain the attitude of the box after construction. The primary difference being, rather than the tab 70 and recess 60 means of securing the bottom, glue, tape, staples, or a similar securing means would be required. As such, the free edges 34 of the flaps need not be configured so as to form the recess 60 or securing tab 70. For added stability, corner tabs 36, may be secured to a pallet by clamping, nailing, stapling, etc.

One of ordinary skill in the art will realize that similar notching and flap systems can be used in boxes having varying numbers of sides, i.e., hexagonal boxes. One of ordinary skill in the art will realize that embodiments of the present invention are envisioned that have dimensions ranging from a few inches up to several feet, depending on the use of the box.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A box formed from a unitary blank of material, comprising:
a plurality of sidewalls, each of said plurality of sidewalls being foldably connected to adjacent sidewalls;
a plurality of flaps, said plurality of flaps including a main flap, a pair of side flaps, and a closure flap, each of said flaps including at least an attached edge, a pair of side edges, and a free edge, each of said flaps being foldably connected to a separate one of said side walls;
a plurality of alignment notches, each of said alignment notches being arranged and configured to engage an adjacent said side edge of an adjacent said flap; and
wherein each of said side edges of said main flap includes one of said alignment notches, and said main flap, said pair of side flaps, and said closure flap form a bottom of said box when folded perpendicular to said plurality of side walls.

2. The box of claim 1, wherein each of said side flaps further includes one of said plurality of alignment notches disposed on said side edge adjacent said closure flap.

3. The box of claim 2, further comprising means for securing said closure flap to another of said plurality of flaps.

4. The box of claim 2, wherein said plurality of sidewalls further comprises eight sidewalls.

5. The box of claim 2, further comprising:
a recess formed by said free edges of said main flap and said pair of side flaps;
a securing tab disposed on said free edge of said closure flap; and
wherein said recess is arranged and configured to receive said securing tab, thereby interlocking said plurality of tabs to form said bottom.

6. The box of claim 2, further comprising a plurality of corner tabs, each of said corner tabs being disposed on one of said flaps and extending outwardly beyond said plurality of sidewalls.

7. The box of claim 2, wherein said main flap includes two of said corner tabs and each of said pair of side flaps includes one of said corner tabs.

8. A method of forming a box from a unitary blank in which said box includes a first portion, a second portion, a securing means, a plurality of sidewalls, a main flap, a pair of side flaps, a closure flap, a securing tab, a recess, a first and a second pair of alignment notches, and a bottom, comprising the steps of:
folding said unitary blank such that said plurality of sidewalls is formed, one of said sidewalls including said first and said second portion;
joining said first and said second portions with said securing means;
engaging said pair of side flaps with said first pair of alignment notches disposed on said main flap by folding said main flap inwardly until said main flap is perpendicular to said plurality of sidewalls;
folding each of said pair of side flaps inwardly until each of said side flaps is perpendicular to said plurality of sidewalls;
folding said closure flap inwardly until said closure flap is perpendicular to said plurality of sidewalls; and
securing said closure flap in position perpendicular to said plurality of sidewalls, thereby forming said bottom of said box.

9. The method of claim 8, wherein said step of folding said pair of side flaps further comprises engaging said closure flap with said second pair of alignment notches, one of each said second pair of alignment notches being disposed on one each of said pair of side flaps.

10. The method of claim 9, wherein said securing step further comprises one of gluing, taping, or stapling said closure flap to at least one of said main flap or one of said pair of side flaps.

11. The method of claim 9, wherein said securing step further comprises positioning said securing tab disposed on said closure flap into said recess formed by said main flap and said pair of side flaps.

12. A unitary blank for forming a box, comprising:
a plurality of sidewall panels;
a plurality of alignment notches;
a plurality of flaps including a main flap and a pair of side flaps, each of said plurality of flaps including an attached edge, a pair of side edges, and a free edge, each of said plurality of flaps being foldably connected to a separate one of said plurality of sidewalls; and
wherein said main flap is disposed between said pair of side flaps, and each of said side edges of said main flap includes one of said plurality of alignment notches, each of said alignment notches being arranged and configured to engage one of said side edges of each said pair of side flaps.

13. The unitary blank of claim 12, wherein said plurality of flaps further comprises a closure flap.

14. The unitary blank of claim 12, wherein each said pair of side flaps further includes one of said plurality of alignment notches disposed on one of said side edges, each of said alignment notches being arranged and configured to engage one of said side edges of said closure flap.
